(19) United States
(12) Patent Application Publication
(10) Pub. No.: US 2007/0160136 A1
(43) Pub. Date: Jul. 12, 2007

(54) Method and apparatus for motion prediction using inverse motion transform

(75) Inventors: Tammy Lee, Seoul (KR); Kyo-Hyuk Lee, Yongin-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/650,519

(22) Filed: Jan. 8, 2007

Related U.S. Application Data
(60) Provisional application No. 60/758,222, filed on Jan. 12, 2006.

(30) Foreign Application Priority Data
May 9, 2006 (KR) 10-2006-0041700

(51) Int. Cl. H04B 1/66; H04N 11/02

(52) U.S. Cl. 375/240.1; 375/240.16

(57) ABSTRACT

A method and apparatus for performing a motion prediction using an inverse motion transformation are provided. The method includes generating a second motion vector by inverse-transforming a first motion vector of a second block in a lower layer, the second block corresponding to a first block in a current layer; predicting a motion vector of the first block using the second motion vector; and encoding the first block using the predicted motion vector. The apparatus includes a motion vector inverse-transforming unit that generates a second motion vector by inverse-transforming a first motion vector of a second block in a lower layer corresponding to a first block in a current layer; a predicting unit that predicts a motion vector of the first block using the second motion vector; and an inter-prediction encoding unit that encodes the first block using the predicted motion vector.

### CROSS-REFERENCE TO RELATED APPLICATION

This application claims priority from Korean Patent Application No. 10-2006-0041700 filed on May 9, 2006 in the Korean Intellectual Property Office, and U.S. Provisional Patent Application No. 60/758,222 filed on Jan. 12, 2006 in the United States Patent and Trademark Office, the disclosures of which are incorporated herein by reference in their entirety.

### BACKGROUND OF THE INVENTION

1. Field of the Invention

Apparatuses and methods consistent with the present invention relate to encoding and decoding a video signal, and more particularly, to a method and apparatus for motion prediction using an inverse motion transform.

2. Description of the Related Art

With the development of information technologies including the Internet, there have been increasing multimedia services containing various kinds of information such as text, video, and audio. Multimedia data is usually large and requires large capacity storage media and a wide bandwidth for transmission. Accordingly, a compression coding method is a requisite for transmitting multimedia data.

One goal of data compression is removing redundancy. Data can be compressed by removing spatial redundancy in which the same color or object is repeated in an image, temporal redundancy in which there is little change between adjacent frames in a moving image or the same sound is repeated in audio, or psychovisual redundancy which takes into account human eyesight and its limited perception of high frequency. In general video coding, temporal redundancy is removed by motion estimation and compensation, and spatial redundancy is removed by transform coding.

To transmit multimedia data, transmission media are used. Transmission performance is different depending on the transmission media. Currently used transmission media have various transmission rates. For example, an ultrahigh-speed communication network can transmit data of several tens of megabits per second while a mobile communication network has a transmission rate of 384 kilobits per second. Accordingly, to support transmission media having various speeds or to transmit multimedia at a data rate suitable to a transmission environment, data coding methods having scalability, such as wavelet video coding, subband video coding, or the like, may be suitable for a multimedia environment.

Scalable video coding is a technique that allows a compressed bitstream to be decoded at different resolutions, frame rates, and signal-to-noise ratio (SNR) levels by truncating a portion of the bitstream according to ambient conditions such as transmission bit-rates, error rates, system resources, or the like. Motion Picture Experts Group 4 (MPEG-4) Part 10 standardization for scalable video coding is being developed. In particular, much effort is being made to implement scalability based on a multi-layered structure. For example, a bitstream may consist of multiple layers, i.e., a base layer and first and second enhanced layers with different resolutions (e.g., common intermediate format (CIF), quarter CIF (QCIF), or 2CIF) or frame rates.

Like when a video is coded into a singe layer, when a video is coded into multiple layers, a motion vector (MV) is obtained for each of the multiple layers to remove temporal redundancy. The MV may be separately searched for each layer, or a motion vector obtained by a motion vector search for one layer is used for another layer (without or after being upsampled/downsampled). In the former case of separately searching, however, in spite of the benefit obtained from accurate motion vectors, there still exists overhead due to motion vectors generated for each layer. Thus, it is difficult to efficiently reduce the redundancy between motion vectors for each layer.

FIG. 1 shows an example of a scalable video codec using a multi-layer structure. Referring to FIG. 1, a base layer has the quarter common intermediate format (QCIF) resolution and a frame rate of 15 Hz, a first enhancement layer has a common intermediate format (CIF) resolution and a frame rate of 30 Hz, and a second enhancement layer has a standard definition (SD) resolution and a frame rate of 60 Hz. For example, in order to obtain a CIF 0.5 Mbps stream, a first enhancement layer bitstream (CIF_{—}30 Hz_{—}0.7M) is truncated to match a target bit-rate of 0.5 Mbps. In this way, it is possible to provide spatial, temporal, and signal-to-noise ratio (SNR) scalabilities.

As shown in FIG. 1, frames (e.g., 10, 20, and 30) at the same temporal position in each layer can be considered to be similar images. One known coding technique includes predicting texture of current layer from texture of a lower layer (directly or after upsampling) and coding a difference between the predicted value and actual texture of the current layer. This technique is defined as Intra_BL prediction in scalable video model 3.0 of ISO/IEC 21000-13 scalable video coding (“SVM 3.0”).

The SVM 3.0 employs a technique for predicting a current block using correlation between a current block and a corresponding block in a lower layer in addition to directional intra-prediction and inter-prediction used in related art H.264 to predict blocks or macroblocks in a current frame. The prediction method is called “Intra_BL prediction” and a coding mode using the Intra_BL prediction is called an “Intra_BL mode”.

FIG. 2 is a schematic diagram for explaining three prediction methods: \textcircled{1} an intra-prediction for a macroblock 14 in a current frame 11; (2) an inter-prediction using a frame 12 at a different temporal position from the current frame 11; and (3) an Intra_BL prediction using texture data from a region 16 in a base layer frame 13 corresponding to the macroblock 14.

The scalable video coding standard selects an advantageous method of the three prediction methods for each macroblock.

In the inter-prediction using a frame at a different temporal position from the current frame, a B-frame referring to backward and forward frames may exist. If the B frame has multi-layers, it may refer to the lower layer motion vector. However, a case exists where a lower layer frame has no bidirectional motion vectors, as shown in FIG. 3.

FIG. 3 illustrates a related art two-way motion vector prediction. In FIG. 3, a block in a current frame 320 has motion vectors (cMV0 and cMV1), which refer to a block in a backward frame 310 and a forward frame 330, respectively. The motion vectors (e.g., cMV0 and cMV1) may refer to the lower layer motion vector (e.g., bMV0) because they may be obtained using a residual with the lower layer motion vector; however, the cMV1 cannot refer to the lower layer motion vector if a block in a frame 322 does not refer to a block in a forward frame 332. A method and apparatus for predicting a motion vector is desirable for the situation where a lower layer motion vector cannot be used.

### SUMMARY OF THE INVENTION

The present invention provides a method and apparatus which performs motion prediction using a result of inverse-transforming the existing motion vector when the lower layer motion vector does not exist.

The present invention also provides a method and apparatus which improves an encoding efficiency by performing motion prediction even when the lower layer motion vector does not exist.

According to an aspect of the present invention, there is provided a method of encoding a video signal corresponding to a method of encoding blocks composing a multi-layered video signal. The method of encoding a signal includes generating a second motion vector by inverse-transforming a first motion vector of a second block in a lower layer, the second block corresponding to a first block in a current layer; predicting a motion vector of the first block using the second motion vector; and encoding the first block using the predicted motion vector.

According to another aspect of the present invention, there is provided a method of decoding a video signal by decoding blocks composing a multi-layered video signal. The method includes generating a second motion vector by inverse-transforming a first motion vector of a second block in a lower layer corresponding to a first block in a current layer; predicting a motion vector of the first block using the second motion vector; and decoding the first block using the predicted motion vector.

According to further aspect of the present invention, there is provided a video encoder corresponding to an encoder that encodes blocks composing a multi-layered video signal. The video signal encoder includes a motion vector inverse-transforming unit that generates a second motion vector by inverse-transforming a first motion vector of a second block in a lower layer corresponding to a first block in a current layer; a predicting unit that predicts a motion vector of the first block using the second motion vector; and an inter-prediction encoding unit that encodes the first block using the predicted motion vector.

According to still another aspect of the present invention, there is provided a video decoder corresponding to a decoder that decodes blocks composing a multi-layered video signal. The video decoder includes a motion vector inverse-transforming unit that generates a second motion vector by inverse-transforming a first motion vector of a second block in a lower layer corresponding to a first block in a current layer; a predicting unit that predicts a motion vector of the first block using the second motion vector; and an inter-prediction decoding unit that decodes the first block using the predicted motion vector.

### BRIEF DESCRIPTION OF THE DRAWINGS

The above and other aspects of the present invention will become apparent by describing in detail exemplary embodiments thereof with reference to the attached drawings, in which:

FIG. 1 illustrates an example of a scalable video codec using a multi-layer structure;

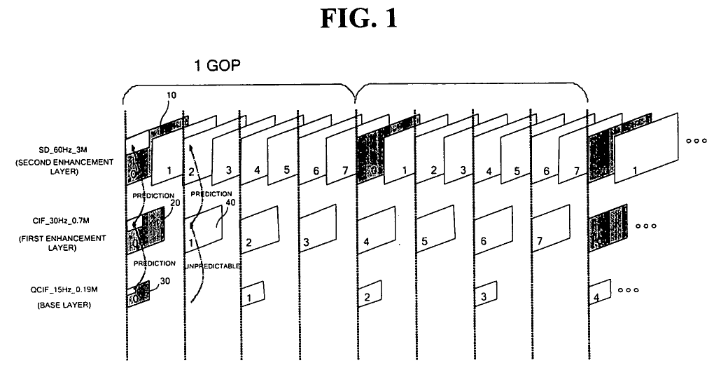

FIG. 2 is a schematic diagram for explaining Inter-prediction, Intra-prediction, and Intra-BL prediction;

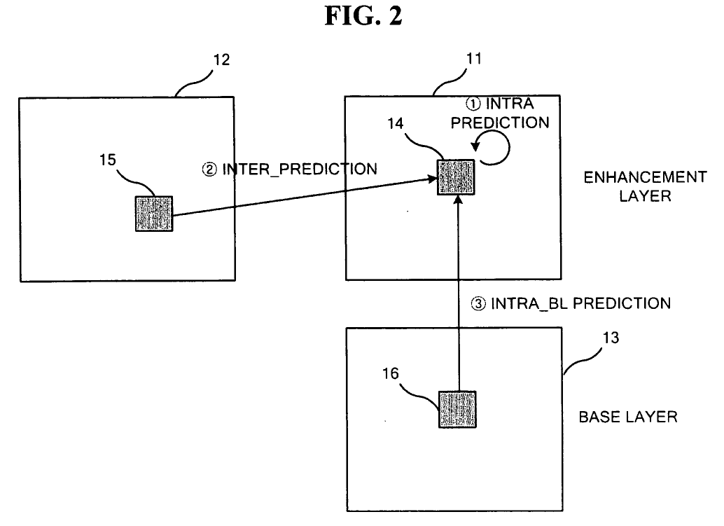

FIG. 3 illustrates a related art two-way motion vector prediction;

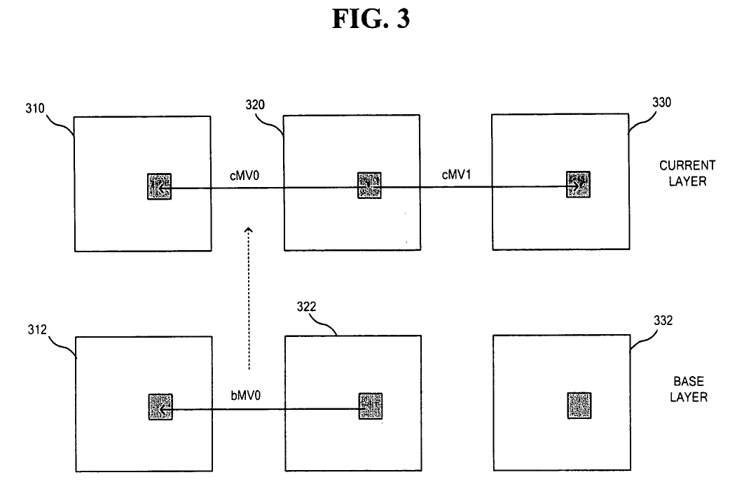

FIG. 4 illustrates a process for predicting by inverse-transforming a base layer motion vector according to an exemplary embodiment of the present invention;

FIG. 5 illustrates a process for inverse-transforming a base layer motion vector in a decoder according to an exemplary embodiment of the present invention;

FIG. 6 illustrates an encoding process according to an exemplary embodiment of the present invention;

FIG. 7 illustrates a decoding process according to an exemplary embodiment of the present invention;

FIG. 8 illustrates a configuration of an enhancement layer encoding unit 800 according to an exemplary embodiment of the present invention;

FIG. 9 illustrates a configuration of an enhancement layer decoding unit 800 according to an exemplary embodiment of the present invention; and

FIG. 10 is a result according to an exemplary embodiment of the present invention.

### DETAILED DESCRIPTION OF EXEMPLARY EMBODIMENTS OF THE INVENTION

Advantages and features of the aspects of the present invention and methods of accomplishing the same may be understood more readily by reference to the following detailed description of exemplary embodiments and the accompanying drawings. The aspects of the present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims.

The present invention is described hereinafter with reference to a block diagram or flowchart illustrations of an access point and a method for transmitting motion intensity histogram (MIH) protocol information according to exemplary embodiments of the invention. It should be understood that each block in the flowchart and combinations of blocks in the flowchart can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus creates ways for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instructions that implement the function specified in the flowchart block or blocks.

The computer program instructions may also be loaded into a computer or other programmable data processing apparatus to cause a series of operations to be performed in the computer or other programmable apparatus to produce a computer implemented process such that the instructions that execute in the computer or other programmable apparatus provide operations for implementing the functions specified in the flowchart block or blocks.

And each block in the flowchart illustrations may represent a module, segment, or portion of code which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

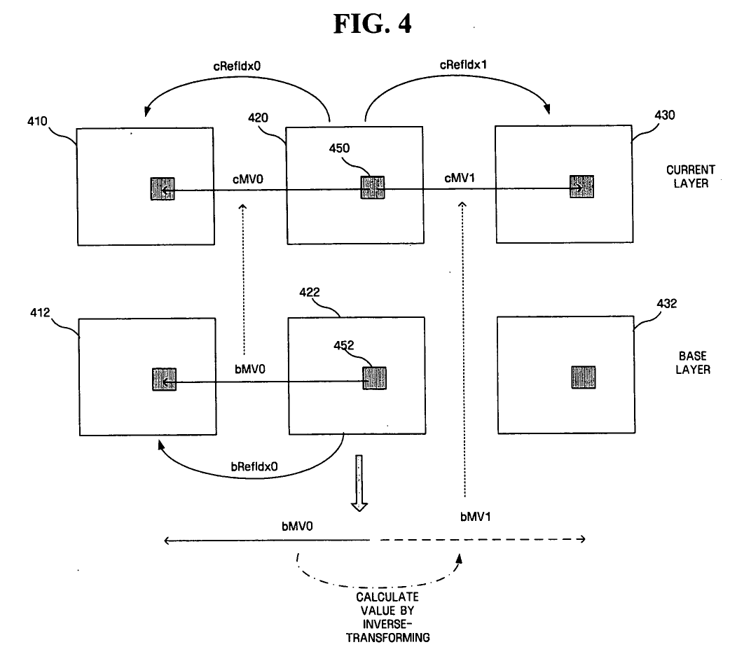

FIG. 4 illustrates a prediction process using inverse-transforming of a base layer motion vector according to an exemplary embodiment of the present invention.

Numerals 410, 420, 430, 412, 422, and 432 of FIG. 4 may denote a frame, a block, or a macroblock. Numerals 410 through 432 of FIG. 4 are described as a frame for convenience, which is an example; they are also described as a sub block and a macroblock.

The block or macroblock 450 included in frame 420 denotes a block of a frame at a backward and forward temporal position. The motion vector cMV0 corresponds to a block of a previous frame. The motion vector cMV1 corresponds to a block of a next frame. The cMV0 may be called a backward motion vector and the cMV1 may be called a forward motion vector. The variables cRefIdx0 and cRefIdx1 show that a bidirectional motion vector exists. If a motion vector exists in the lower layer, a current layer motion vector may be calculated through the lower layer motion vector. The block 450 may generate cMV1 by referring to a motion vector (e.g., bMV1) of a block 452 of a frame 422, which exists at a same temporal position in the lower layer.

Since the block 450 is a two-way block, the cMV0 value is also used for coding. If the block 452 refers to only one-way (e.g., bMV0 as illustrated in FIG. 4), it may refer to a value calculated by inverse-transforming the existing motion vector. The bMV1 does not exist in the lower layer; however, cMV1 may be calculated through the bMV1 obtained by inverse-transforming the bMV0, i.e., multiplying bMV0 by −1.

As illustrated in FIG. 4, if a lower block (e.g., block 452) performs only a backward or a forward predication, with the other prediction not existing in the lower block, the other prediction may be calculated by inverse-transforming the predicted value.

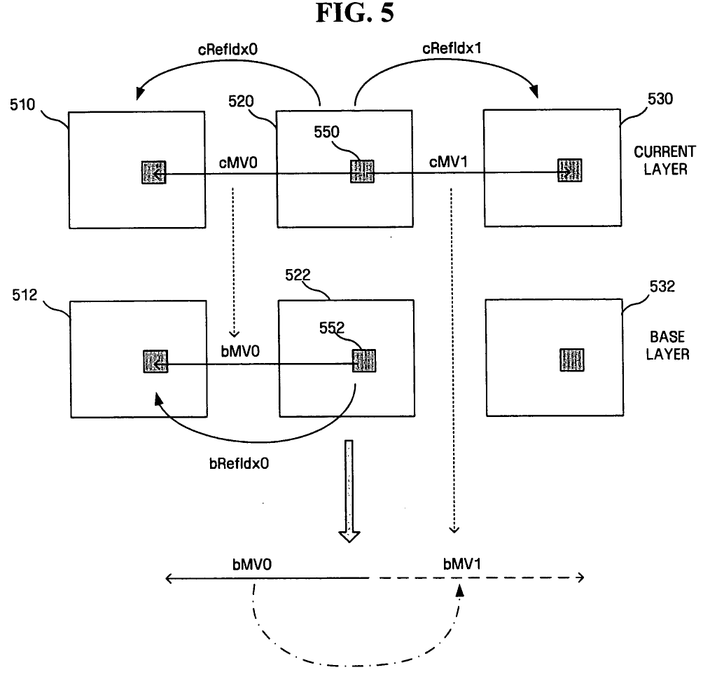

FIG. 5 illustrates a process for inverse-transforming a base layer motion vector in a decoder according to an exemplary embodiment of the present invention.

A block 550 of a frame 520 has backward motion vector (cMV0) and forward motion vector (cMV1) values of a backward and forward frame 510 and 530, respectively. Since the values are calculated through the lower layer motion vector, the lower layer motion vector must be calculated.

A block 552 of a lower layer frames 522 has only a motion vector (bMV0) referring to a block of a backward frame 512. Accordingly, a value of bMV1 referring to a block of a forward frame 532 does not exist. Since three frames are at successive temporal positions, an inverse-value of the calculated vector is obtained by multiplying the calculated vector by −1. The cMV1 can be calculated based on the above result (bMV1).

In FIGS. 4 and 5, a motion_prediction_flag may be used to notify a prediction in the lower layer motion vector.

When referring to a backward block, the prediction refers to a block indicated by RefIdx0. When referring to a forward block, the prediction refers to a block indicated by RefIdx1. If RefIdx0 or RefIdx1 is set, an exemplary embodiment of the present invention may be applied when RefIdx0 or RefIdx1, which indicate a same block of the lower layer, exists.

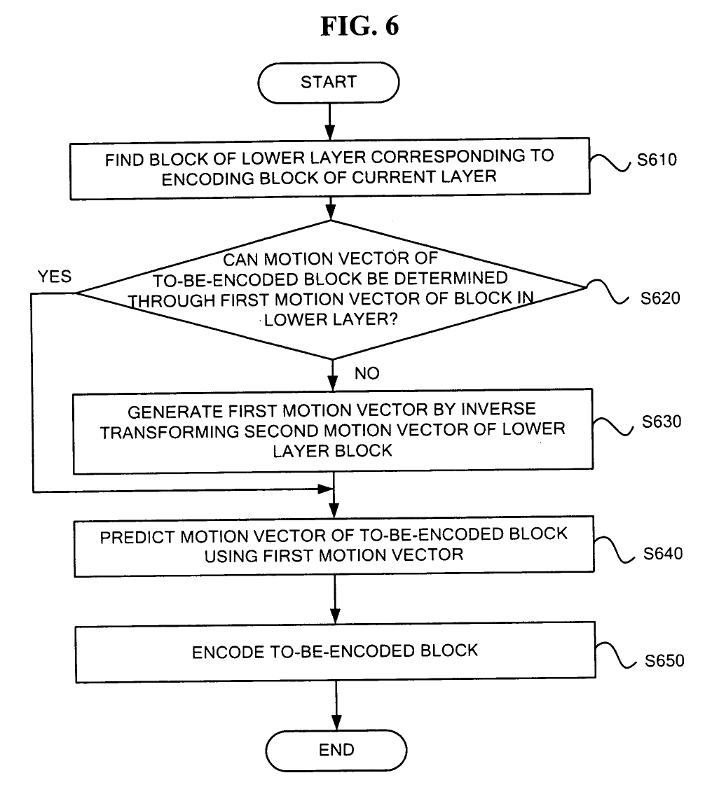

FIG. 6 illustrates an encoding process according to an exemplary embodiment of the present invention.

A block of a lower layer corresponding to encoding a block of a current layer is found (S610). It is determined whether a motion vector of the to-be-encoded block may be predicted through a first motion vector of the block in the lower layer (S620). For example, in FIG. 4, the cMV0 may be predicted, but cMV1 cannot be predicted because bMV1 does not exist.

If the prediction is not possible, a first motion vector is generated by inverse-transforming a second motion vector of the lower layer block (S630). A motion vector of the to-be-encoded block is predicted using the first motion vector (S640). The to-be-encoded block is encoded using the predicted result or residual data (S650). If the prediction is possible in operation S620, a process of encoding is performed without operation S630.

Blocks referred to by the second and first motion vectors are located at the same temporal position and the temporally opposite direction based on the lower layer block as a temporal standard. For example, a picture order count (POC) of the block referred to by the first motion vector is 10 and a POC of the block referred to by the second motion vector is 10. The POC of the block in the lower layer is 11.

The blocks are at the same temporal position and the opposite temporal direction. And, the movement or change of textures is likely to be similar over time; therefore, a motion vector referring to a block that is located at the opposite temporal position can be used after being inverse-transformed.

The above process compared with FIG. 4 is as follows.

The to-be-encoded block in the video encoder is the block 450. The block includes a macroblock or a sub-block. When cMV1 cannot be predicted using the motion vector of the block 452 in the lower layer, an encoder generates bMV1 by inverse-transforming the other motion vector of the block 452, i.e., bMV0. And the cMV1 can be predicted by the generated bMV1. The video encoder may encode the block 450 using cMV1. Frames 410 and 412 referred to by cMV0 and bMV0, respectively, are at a same temporal position. A difference between frames 430 and 420 referred to by cMV1 may be the same as a difference between frames 410 and 420.

The first or second motion vector in FIGS. 4 and 6 is an example of a case where one block may have two motion vectors through the Inter-prediction. If the first motion vector refers to a backward block, the second motion vector refers to a forward block. If the first motion vector refers to a forward block, the second motion vector refers to a backward block.

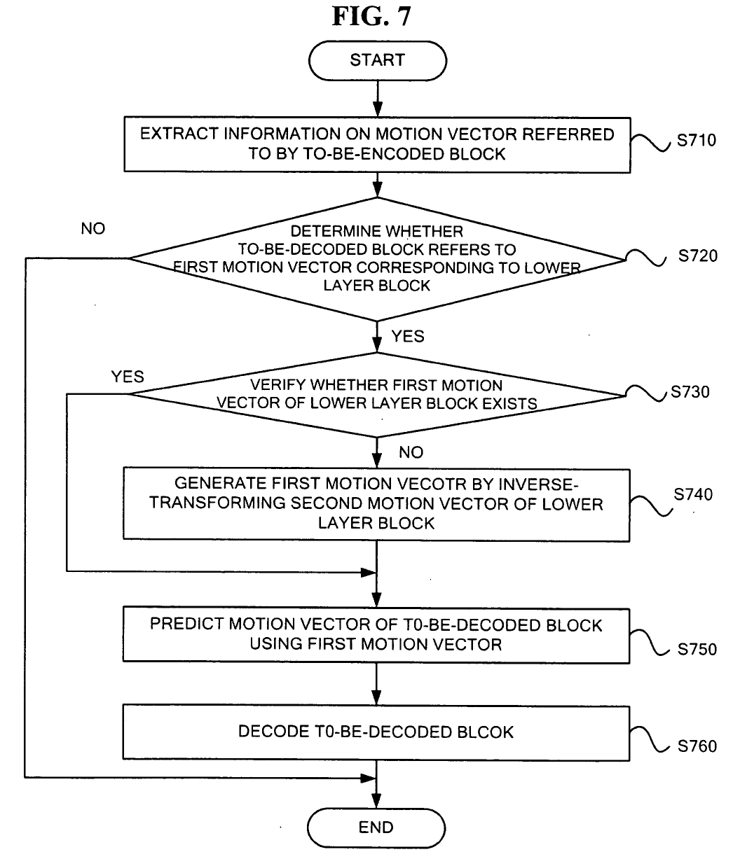

FIG. 7 illustrates a decoding process according to an exemplary embodiment of the present invention.

A video decoder decodes a received or stored video signal. The video decoder extracts information on a motion vector referred to by a to-be-decoded block (S710). Information on a reference frame/picture such as the RefIdx0 or the RefIdx1 is on a list0 and list1 as an exemplary embodiment of the motion vector. It is possible to know whether to refer to the lower layer motion vector through information such as the motion_prediction_flag. It is determined whether the block refers to the first motion vector of the block in the lower layer (S720). If it is determined that the block in the above result does not refer to the first motion vector in the lower layer, the block is decoded through a related art method or another method.

If it is determined that the first motion vector of the block in the lower layer is referred to, it is verified that the first motion vector exists (S730). If the first motion vector does not exist, the first motion vector is generated by inverse-transforming the second motion vector of the block in the lower layer (S740).

The first and second motion vectors refer to blocks located at the same temporal position and the opposite temporal direction, which was described with reference to FIG. 6 above.

The above process compared with FIG. 5 is as follows.

The to-be-decoded block in the video encoder is the block 550. The block includes a macroblock or a sub-block. The cRefIdx1 shows that the cMV1 refers to a picture/frame 530 and a lower layer motion vector through information such as motion_prediction_flag (not shown in FIG. 5). When the block 552 in the lower layer does not have a motion vector referring to a picture/frame 532 that is located at the same temporal position as the picture 530, a decoder generates bMV1 by inverse-transforming the other motion vector of the block 552, i.e., bMV0. And cMV1 can be predicted by the generated bMV1. The video decoder may decode the block 550 using cMV1. Frames 510 and 512 referred to by the cMV0 and bMV0, respectively, are at a same temporal position. A difference between frames 530 and 520 referred to by the cMV1 may be the same as a difference between frames 510 and 520.

The inverse-transformation in the decoding process is as follows.

It assumed that refPicBase is a picture referred to by a syntax element of ref_idx_IX[mbPartIdxBase] of the macro block in a base layer (X is 1 or 0). If it is possible to use the ref_idx_IX[mbPartIdxBase], the refPicBase is a picture referred to by the ref_idx_IX[mbPartIdxBase]. If it is impossible to use ref_idx_IX[mbPartIdxBase], refPicBase selects another. That is, if it is impossible to use ref_idx_I0[mbPartIdxBase], refPicBase selects ref_idx_I1[mbPartIdxBase]. And if it is impossible to use ref_idx_I1[mbPartIdxBase], the refPicBase selects ref_idx_I0[mbPartIdxBase]. Then a motion vector corresponding to the selected picture may be inverse-transformed by multiplying it by −1, which is also applied to a luma motion vector prediction in the base layer.

The term “module,” as used herein, refers to, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, components and modules may be implemented so as to reproduce one or more CPUs within a device or a secure multimedia card.

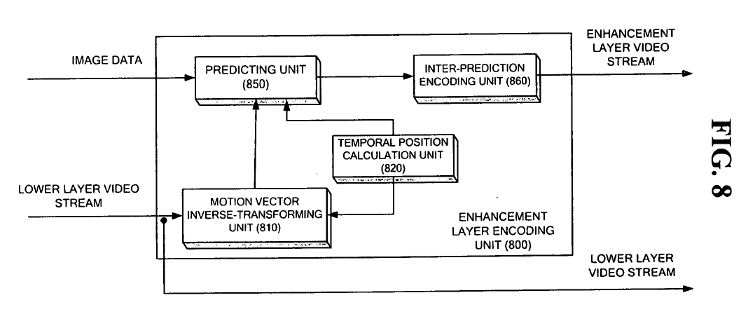

FIG. 8 illustrates a configuration of an enhancement layer encoding unit 800, which encodes an enhancement layer, of a video encoder according to an exemplary embodiment of the present invention. The base layer encoding process of and a quantizing process for encoding a video signal are known in the art, and will be omitted here.

The enhancement layer encoding unit 800 includes a motion vector inverse-transforming unit 810, a temporal position calculation unit 820, a predicting unit 850, and an Inter-prediction encoding unit 860. Image data is input to the predicting unit 850 and image data in a lower layer is input to the motion vector inverse-transforming unit 810.

The motion vector inverse-transforming unit 810 generates a second motion vector by transforming a first motion vector of a second block in the lower layer corresponding to a first block of a current layer. In FIG. 4, bMV1 is generated using bMV0. The predicting unit 850 performs the motion prediction for image data of the current layer (enhancement layer) using the motion vector generated by the inverse-transformation. The temporal position calculating unit 820 calculates a temporal position or information to know which motion vector is inverse-transformed when the motion vector inverse-transforming unit 810 inverse-transforms the motion vector. The prediction of the predicting unit 850 is output to the enhancement layer video stream via the Inter-prediction encoding unit 860.

As illustrated in FIG. 4, the predicting unit 850 predicts a backward or forward motion vector of the to-be-encoded block. To predict the motion vector, a motion vector of the block in the lower layer is used. When a motion vector of the block in the lower layer does not exist, the motion vector inverse-transforming unit 810 inverse-transforms a motion vector referring to a block at the opposite temporal position.

The enhancement layer refers to the lower layer that may be a base layer, fine granular scalability (FGS) layer, or a lower enhancement layer.

The predicting unit 850 may calculate a residual with the lower layer motion vector generated by the inverse-transformation. The Inter-prediction encoding unit 860 may set information such as motion_prediction_flag to notify that the prediction refers to the lower layer motion vector.

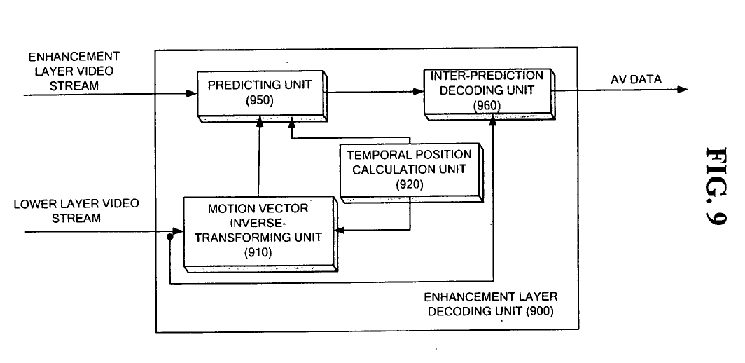

FIG. 9 illustrates a configuration of an enhancement layer decoding unit 900 according to an exemplary embodiment of the present invention. An encoding process of a base layer and a quantizing process for encoding a video signal are known in the art, and will be omitted.

The enhancement layer decoding unit 900 includes a motion vector inverse-transforming unit 910, a temporal position calculation unit 920, a predicting unit 950, and an Inter-prediction decoding unit 960. A lower layer video stream is input to the motion vector inverse-transforming unit 910. An enhancement layer video stream is input to the predicting unit 950 that verifies whether a motion vector of a specific block of the enhancement layer video stream refers to a lower layer motion vector. When the motion vector of the specific block refers to the lower layer motion vector, if a motion vector does not exist in the lower layer video stream, the motion vector to be inverse-transformed is selected via the temporal position calculating unit 920, and the motion vector inverse-transforming unit 910 inverse-transforms the motion vector. The above was described in FIGS. 5 through 7. The predicting unit 950 predicts a motion vector of the corresponding block using the inverse-transformed motion vector of the lower layer. The Inter-prediction decoding unit 960 decodes the block using the predicted motion vector. The decoding image data is restored, and output.

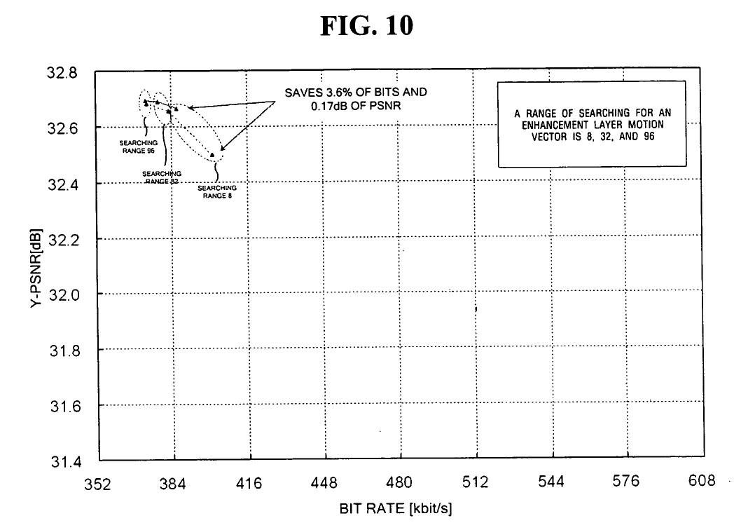

FIG. 10 is an experiential result according to an exemplary embodiment of the present invention. In FIG. 10, a range of searching for an enhancement layer motion vector is 8, 32, and 96, and four CIF sequences are used thereto. An enhancement of the greatest function saves 3.6% of bits and peak signal-to-noise ratio (PSNR) is about 0.17 dB.

Table 1 shows a comparison of the enhancement in FIG. 10.

TABLE 1
Results of the Comparison of FIG. 10

| | |
|---|---|
| Related Art | Present invention |

| | Bit Rate | PSNR | Bit Rate | PSNR |
|---|---|---|---|---|
| 8 | 401.00 | 32.50 | 386.50 | 32.67 |
| 32 | 383.07 | 32.66 | 378.62 | 32.69 |
| 96 | 373.77 | 32.68 | 373.27 | 32.69 |

As described above, an aspect of the present invention is related to performing the motion prediction using inverse-transforming the existing motion vector if a lower layer motion vector does not exist.

Another aspect of the present invention is related to improving an encoding efficiency by performing the motion prediction even when a lower layer motion vector does not exist.

Exemplary embodiments of the aspects of the present invention have been described with respect to the accompanying drawings. However, it will be understood by those of ordinary skill in the art that various replacements, modifications and changes may be made in the form and details without departing from the spirit and scope of the present invention as defined by the following claims. Therefore, it is to be appreciated that the above described exemplary embodiments are for purposes of illustration only and are not to be construed as a limitation of the invention.

What is claimed is:

1. A method of encoding a video signal, the method comprising:
generating a second motion vector by inverse-transforming a first motion vector of a second block in a lower layer, the second block corresponding to a first block in a current layer;
predicting a motion vector of the first block using the second motion vector; and
encoding the first block using the predicted motion vector.

2. The method of claim 1, wherein the predicting the motion vector comprises predicting a backward or forward motion vector, and the first motion vector is a motion vector at a backward or forward temporal position with reference to the second block.

3. The method of claim 1, wherein the predicting the motion vector comprises calculating a residual between the first or second motion vector of the lower layer and a corresponding motion vector of the current layer.

4. The method of claim 2, wherein the backward or forward motion vector of the first block is a motion vector referring to a backward or forward block relative to the first block, and the predicting the backward or forward motion vector comprises calculating a residual between the first or second motion vector of the lower layer and a corresponding backward or forward motion vector of the current layer

5. The method of claim 1, further comprising:
storing information on a block referred to by the motion vector of the first block after the predicting.

6. The method of claim 2, further comprising storing information on a block referred to by the backward or forward motion vector of the first block after the predicting.

7. The method of claim 1, wherein the lower layer is a base layer.

8. The method of claim 4, wherein a block referred to by the first motion vector and the block referred to by the backward or forward motion vector of the first block are located at the same temporal position.

9. A method of decoding a video signal, the method comprising:
generating a second motion vector by inverse-transforming a first motion vector of a second block in a lower layer corresponding to a first block in a current layer;
predicting a motion vector of the first block using the second motion vector; and
decoding the first block using the predicted motion vector.

10. The method of claim 9, wherein the predicting a motion vector comprises predicting a backward or forward motion vector, and wherein the first motion vector is a motion vector at a backward and forward temporal position relative to the second block.

11. The method of claim 10, wherein the predicting comprises calculating a residual between the first or second motion vector of the lower layer and a corresponding motion vector of the current layer.

12. The method of claim 11, wherein the backward or forward motion vector of the first block is a motion vector referring to a backward or forward block relative to the first block, and the predicting comprises calculating a residual between the first or second motion vector of the lower layer and a corresponding backward or forward motion vector of the current layer.

13. The method of claim 9, further comprising:
abstracting information on a block referred to by the motion vector of the first block before the predicting.

14. The method of claim 10, further comprising abstracting information on a block referred to by the backward or forward motion vector of the first block before the predicting.

15. The method of claim 9, wherein the lower layer is a base layer.

16. The method of claim 10, wherein a block referred to by the first motion vector and the block referred to by the backward or forward motion vector of the first block are located at the same temporal position.

17. A video encoder comprising:
a motion vector inverse-transforming unit that generates a second motion vector by inverse-transforming a first motion vector of a second block in a lower layer corresponding to a first block in a current layer;
a predicting unit that predicts a motion vector of the first block using the second motion vector; and
an inter-prediction encoding unit that encodes the first block using the predicted motion vector.

18. The video encoder of claim 17, wherein the predicting unit predicts a backward or forward motion vector, and the first motion vector is a motion vector at a backward or forward temporal position based on the second block.

19. The video encoder of claim 17, wherein the predicting comprises calculating a residual between the first or second motion vector of the lower layer and a corresponding motion vector of the current layer.

20. The video encoder of claim 18, wherein the backward or forward motion vector of the first block is a motion vector referring to a backward or forward block relative to the first block, and the predicting comprises calculating a residual between the first or second motion vector of the lower layer and a corresponding backward or forward motion vector of the current layer.

21. The video encoder of claim 17, wherein the inter-prediction encoding unit stores information on a block referred to by the motion vector of the first block.

22. The video encoder of claim 18, wherein the inter-prediction encoding unit stores information on a block referred to by the backward or forward motion vector of the first block.

23. The video encoder of claim 17, wherein the lower layer is a base layer or a fine granular scalability layer.

24. The video encoder of claim 18, wherein a block referred to by the first motion vector and the block referred to by the backward or forward motion vector of the first block are located at the same temporal position.

25. A video decoder comprising:
a motion vector inverse-transforming unit that generates a second motion vector by inverse-transforming a first motion vector of a second block in a lower layer corresponding to a first block in a current layer;
a predicting unit that predicts a motion vector of the first block using the second motion vector; and
an inter-prediction decoding unit that decodes the first block using the predicted motion vector.

26. The video decoder of claim 25, wherein the predicting unit predicts a forward or backward motion vector, and the first motion vector is a motion vector at a forward or backward temporal position relative to the second block.

27. The video decoder of claim 25, wherein the predicting comprises calculating a residual between the first or second motion vector of the lower layer and a corresponding motion vector of the current layer.

28. The video decoder of claim 26, wherein the backward or forward motion vector of the first block is a motion vector referring to a backward or forward block relative to the first block, and the predicting comprises calculating a residual between the first or second motion vector of the lower layer and a corresponding backward or forward motion vector of the current layer.

29. The video decoder of claim 25, wherein the predicting unit abstracts information on a block referred to by the motion vector of the first block.

30. The video decoder of claim 26, wherein the predicting unit abstracts information on a block referred to by the backward or forward motion vector of the first block

31. The video decoder of claim 25, wherein the lower layer is a base layer or a fine granular scalability layer.

32. The video decoder of claim 28, wherein a block referred to by the first motion vector and the block referred to by the backward or forward motion vector of the first block are located at the same temporal position.
